(19) United States
(12) Patent Application Publication
(10) Pub. No.: US 2008/0317383 A1
(43) Pub. Date: Dec. 25, 2008

(54) Adaptive Point-Based Elastic Image Registration

(75) Inventors: Astrid Franz, Hamburg (DE); Ingwer-Curt Carlsen, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 12/097,530

(22) PCT Filed: Dec. 21, 2006
(86) PCT No.: PCT/IB06/54991

§ 371 Date: Jun. 14, 2008

(30) Foreign Application Priority Data
Dec. 22, 2005 (EP) 05301102.9

(51) Int. Cl. G06K 9/32

(52) U.S. Cl. 382/294

(57) ABSTRACT

A point-based elastic registration method for registering a first image and a second image. A number of prominent feature are identified within the first image using a SIFT algorithm (S1). Then, a single control point is placed (S2) with the source image region at the most prominent SIFT feature and optimal parameter settings in respect thereof are determined (S3) for performing elastic deformation (S4) in respect of the first image so as to optimise a similarity measure. Additional control points are then added (S6) one-by-one at the next most prominent SIFT features, and the elastic deformation process repeated each time (S8) in respect of the new control point set, until a predetermined stopping criterion is met, e.g. the resultant improvement in the similarity measure no longer exceeds some predetermined threshold value. Thus, a high speed, high quality registration method is provided without having to specify the number of control points initially.

The invention relates to the field of digital imaging. In particular, the present invention relates to a method of registering a first image to a second image, to an image processing device and to a software program for registering a first image to a second image.

The goal of image registration, for example, in medical imaging applications, is to compensate for differences in images, for example, due to patient movements, different scanner modalities, changes in the anatomy, etc. Global registration methods such as rigid or affine transformations often cannot cope with local differences. A solution for this is known as elastic registration. Robust elastic registration of medical images is a difficult problem, which is currently the subject of intensive research.

Point-based elastic registration comprises the steps of defining a set of control points relative to a first image and then performing elastic deformation of the first image at these control points, so as to bring the first image into an optimal spatial correspondence with a second image, where the alignment is quantified by a similarity measure. In the case of parametric geometrical transformations, the optimal alignment is reached by computing an optimal parameter setting, which for elastic registration in general means the optimal number and positions of control points as well as the displacement parameters (defining the degree of elastic deformation of the first image) at these control points.

The most widely-used transformation class for elastic image registration are B-splines, which are defined on a regular grid of control points. In general, when a highly elastic deformation of the first image is required, a high density of control points is required to be defined. In the case of a regular grid of control points, this high density would be required to be provided in respect of the whole first image, even if such highly elastic deformation were only required in respect of a small area thereof. At least the displacement parameters in respect of each control point needs to be determined, such that in this case a huge number of parameters would be required to be optimised, which requires a long computation time.

The above-mentioned drawback may be overcome by using transformations based on irregular grids of control points. The positions on the first image of a fixed number of control points are considered as free parameters (to be optimised), which can be changed, together with the control point displacement parameters, during the optimisation process. This allows control points to be moved as required, and enables a high density of control points to be provided in respect of a region of the first image where highly elastic deformation is required, whereas in other image regions, the control point density can be much lower. For example, International Patent Application No. WO 2005/057495 describes a method of elastic deformation in which a force field is applied at several control points to a first image, and the optimal positions of the control points at which the forces are applied are found automatically, so as to minimise the difference between the first and the second images.

However, the number of control points is fixed at the start of the image registration process and remains fixed throughout the process. Since the optimal number and initial relative position of the control points cannot be known in advance of the registration process, a larger number of control points than would otherwise be necessary is required to achieve an acceptable image registration result, which in turn means that the computation capacity and time required to perform the optimisation process is also unnecessarily high.

It is an object of the present invention to provide a method of image registration, wherein the number of control points used can be optimised so as to minimise the computational capacity and time required to perform image registration without loss of quality of the registration result. It is also an object of the invention to provide a corresponding image processing device and software program.

In accordance with the present invention, there is provided a method of registering a first image and a second image, the method comprising:
identifying one or more significant features within said first image;
placing at least one control point at a significant feature within said first image, and determining a first parameter setting defining a position and displacement parameters in respect of said at least one control point so as to elastically deform said first image and thereby to improve the similarity between said first image and said second image, and then repeating the steps of:
placing at least one additional control point within said first image, determining a second parameter setting in respect of said at least one additional control point defining a position and displacement parameters so as to elastically deform said first image and thereby to further improve said similarity between said first image and said second image; until a predetermined criteria is met.

Thus, the object of the invention is achieved by starting with one or more control points (preferably a single control point) placed within the first image in correspondence with significant feature thereof, and iteratively adding new control points after each elastic deformation operation, until a predetermined criteria is met. In this way, the number of control points does not need to be specified in advance and can be automatically adapted to the complexity of the deformation field. In a preferred embodiment, new control points are iteratively added after each elastic deformation operation, preferably at respective identified significant features within the first image, until the similarity between the first image and the second image reaches at least a predetermined level.

Preferably a SIFT (Scale-Invariant Feature Transform) algorithm is used to identify prominent structures within the first image, preferably by measuring how long an image structure survives when blurring the image with wider and wider Gaussian kernels. The longer a structure survives the blurring sequence, the more prominent this structure appears in the image. A SIFT algorithm is a known, powerful algorithm that can be used to extract information from an image. It can given an image, identify interesting points on the image (“features”) and provide a signature for each such point. The keypoint locations thus identified are very precise and highly repeatable, because SIFT uses subpixel localisation and multiple scale keypoint identification.

Preferably, each time one or more additional control points are added, optimal parameter settings in respect of all control points in said first image are determined. Thus, in general, a set of N control points is optimised and the resulting configuration serves as the starting point for the next optimisation of a set of N+M control points, wherein N and M are integers. In one exemplary embodiment of the present invention, M=1, with the single additional control point preferably being placed at the next most significant feature identified within the first image prior to the next optimisation operation. In an exemplary, preferred embodiment therefore, starting from an initial configuration of just one (N=1) control point placed at the most significant feature identified within the first image, control points are added one-by-one until no further (significant) improvement of the similarity between the first image and the second image can be achieved.

Beneficially, the parameter settings of each control point are optimised so as to optimise a similarity measure (which may, as an example, be the squared difference between the first and second images, but many other types of similarity measure may be used, including mutual information or cross-correlation, and the present invention is not necessarily intended to be limited in this regard). In a preferred embodiment, a similarity measure is obtained after each elastic deformation operation and the amount by which the similarity between the first image and the second image has improved (i.e. the improvement in the similarity measure caused by the last iteration) may be determined and compared with a predetermined criterion, wherein an additional one or more control points are added only if said predetermined criterion is not met.

Also in accordance with the present invention, there is provided an image processing device for performing registration of a first image and a second image, the device comprising a memory for storing said second image, means for receiving image data in respect of said first image, and processing means configured to:
identify one or more significant features within said first image;
initially place at least one control point at a significant feature within said first image, and determine a first parameter setting defining a position and displacement parameters in respect of said at least one control point so as to elastically deform said first image and thereby to improve the similarity between said first image and said second image, and then repeat the steps of:
placing at least one additional control point within said first image, determining a second parameter setting in respect of said at least one additional control point defining a position and displacement parameters so as to elastically deform said first image and thereby to further improve said similarity between said first image and said second image; until a predetermined criterion is met.

Still further in accordance with the present invention, there is provided a software program for registering a first image and a second image, wherein the software program causes a processor to:
identify one or more significant features within said first image;
initially, place at least one control point at a significant feature within said first image, and determine a first parameter setting defining a position and displacement parameter in respect of said at least one control point so as to elastically deform said first image and thereby to improve the similarity between said first image and said second image, and then repeat the steps of:
placing at least one additional control point within said first image, and determining a second parameter setting in respect of said at least one additional control point defining a position and displacement parameters so as to elastically deform said first image and thereby to further improve said similarity between said first image and said second image; until a predetermined criterion is met.

These and other aspects of the present invention will be apparent from, and elucidated with reference to, the embodiments described herein.

Embodiments of the present invention will now be described by way of examples only and with reference to the accompanying drawings, in which:

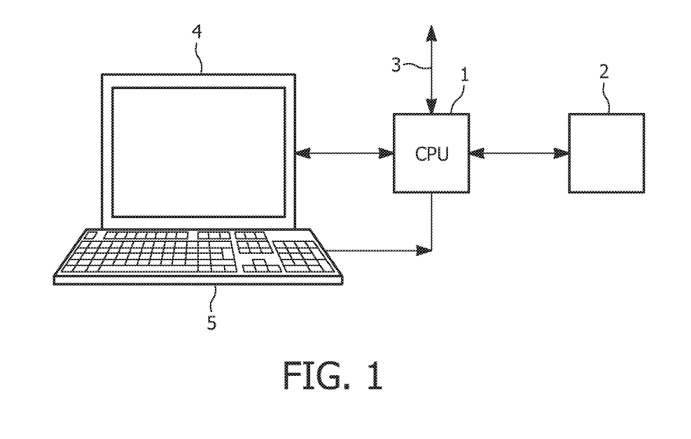

FIG. 1 shows a schematic representation of an image processing device according to an exemplary embodiment of the present invention, adapted to execute a method according to an exemplary embodiment of the present invention; and

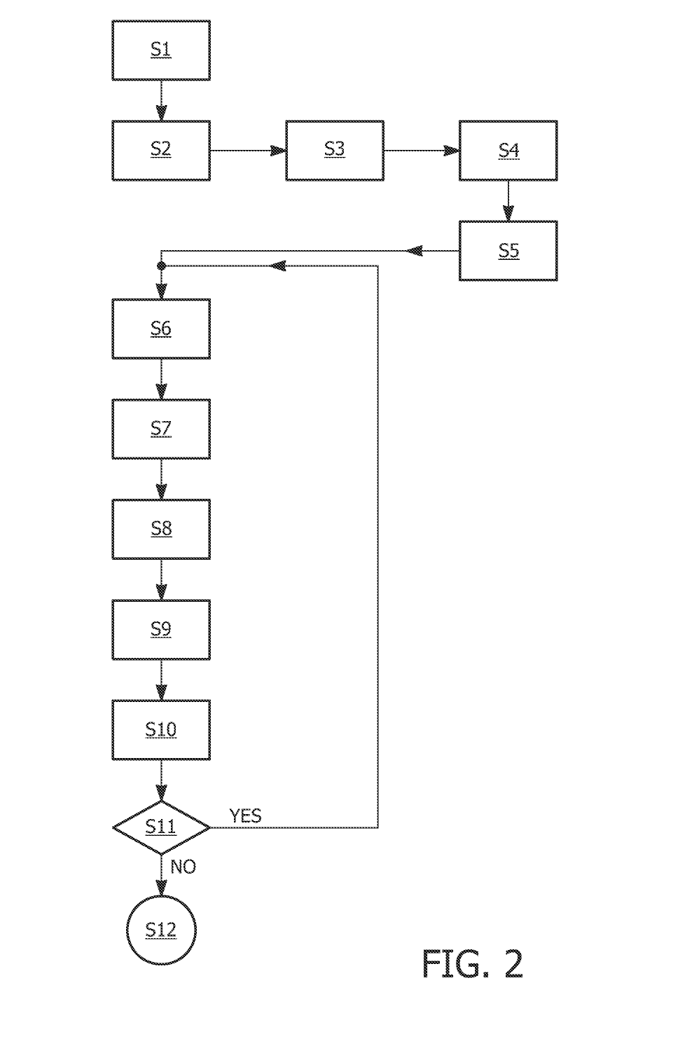

FIG. 2 shows a simplified flow-chart of an exemplary embodiment of a method according to the present invention.

FIG. 1 depicts an exemplary embodiment of an image processing device according to the present invention, for executing an exemplary embodiment of a method in accordance with the present invention. The image processing device depicted in FIG. 1 comprises a central processing unit (CPU) or image processor 1 connected to a memory 2 for storing at least the first and second images, parameter settings of the control points, and first and second similarity measure. The image processor 1 may be connected to a plurality of input/output network or diagnosis devices such as an MR device or a CT device, or an ultrasound scanner. The image processor 1 is furthermore connected to a display device 4 (for example, a computer monitor) for displaying information or images computed or adapted in the image processor 1. An operator may interact with the image processor 1 via a keyboard 5 and/or other input/output devices which are not depicted in FIG. 1.

In spite of the fact that the method is described in the following with reference to medical applications, it should be noted that the present invention can be applied to any multi-dimensional data sets or images required to be registered. For example, the present invention may be applied to quality testing of products, where images of actual products are compared to images of reference products. Also, the method may be applied for material testing, for example, for monitoring changes to an object of interest over a certain period of time.

FIG. 2 shows a flow-chart of an exemplary embodiment of a method for registering a first and second image according to the present invention. At step S1, a SIFT algorithm is used to identify extrema in the scale space defining the first image by measuring how long an image structure survives when blurring the image with wider and wider Gaussian kernals. The longer a structure survives the blurring sequence, the more prominent this structure appears in the image. The SIFT algorithm is known and is described in, for example, “Recognising Panoramas”, M. Brown & D. G. Lowe, Proceedings of the 9^{th} International Conference on Computer Vision, pp 1218-1225, 2005. At step S2, a single control point is placed inside the first image region at the most prominent SIFT feature. Next, the optimal parameter settings for the single control point are computed at step S3, such parameter settings including at least an optimal position within the first image region of the control point, and displacement parameters defining a degree of elastic deformation to be applied to at the control point thus positioned. These parameter settings are thus optimised in order to achieve the best alignment of the first and second images using a single control point. Once the required elastic deformation has been applied at the single control point to the first image at step S4, a similarity measure is calculated at step S5 that represents the degree of alignment between the first and second images, achieved using a single control point. A suitable similarity measure is the squared difference between the first and second images, and the aim of the method of this exemplary embodiment of the present invention is to optimise the similarity measure so as to achieve the best alignment between the two images, whilst minimising the computing capacity and time required to perform the image registration.

Next, at step S6 an additional control point is placed inside the first image region at the next most prominent SIFT feature, and the optimal parameter settings for both of the control points within the first image region are computed at step S7 in order to achieve the best alignment of the first and second images.

Once elastic deformation of the first image with the appropriately positioned control points has been effected at step S8, a new similarity measure is calculated at step S9. The new similarity measure is compared at step S10 with the previously-computed similarity measure according to some predetermined stopping criterion (e.g. the difference is compared with a threshold value). If, at step S11, the predetermined stopping criterion is not met (e.g. the difference between the current and previous similarity measures is at least equal to the threshold value indicating that the similarity between the first and second images has been improved by at least a predetermined amount), the method returns to step S6, where a further control point is added at the next most prominent SIFT feature, and the above process is repeated. Once the stopping criterion is fulfilled (e.g. the difference between the current and previous similarity measures falls below the above-mentioned threshold value), the method ends, at step S12, and the image registration process is complete.

In general, the registration of two images I₁, I₂ consists of finding a transformation t, such that the difference between t(I₁) and I₂ is minimal according to a predefined similarity measure sim. In image registration, it is commonly formed as an optimisation problem such that the parameter vector c, which represents the ideal transformation t_{c}, will maximise an objective function/(c)=corr t_{c}(I₁), I₂). According to an exemplary embodiment of the present invention, therefore, the optimisation problem can be formulated as searching, in respect of each iteration, for optimal positions of a given set of control points in the first image, and their optimal displacement parameters. As will be apparent to a person skilled in the art, many different types of transformation may be used, and examples can be found in, for example, D. Rueckert et al. Comparison and evaluation of rigid, affine and non-rigid registration of breast MR images. Journal of Computer Assisted Tomography 23(5), pp. 800-805, 1999 and V. Pekar, E. Gladilin, K. Rohr. An adaptive irregular grid approach for 3-D deformable image registration. Physics in Medicine and Biology 2005, in press.

The formulated optimisation problem may be solved using standard numerical optimisation techniques, such as, for example, the downhill simplex method as described in J. A. Nelder and R. Mead, A simplex method for function minimisation, Computer Journal, (7): 308-313, 1965.

Thus, starting from a single, control point placed at a prominent SIFT feature within the first image region, a locally convergent optimisation strategy is used to find the optimal configuration for the control point set, where the position and displacement parameters of all control points (including the ones optimised in the previous step) are considered as free parameters. In the first few iterations, the optimisation step in respect of just one or a few control points can be performed very quickly due to the small number of parameters to be optimised. Compared with prior art methods, whereby image registration which uses local optimisation strategies based on a fixed number of control points, the proposed method yields comparable or even better results with a much smaller number of control points. Hence, the proposed method can significantly speed up the image registration process, and meet application-specific quality requirements. This is most important in time-critical applications, such as intra-surgery registration, where optimal registration accuracy has to be achieved over an application-specific region of interest (clinical focus) only. Furthermore, the iterative increase in the number of control points enhances the robustness of the registration algorithm. For applications requiring high accuracy, which can only be achieved using a large number of control points, the termination criterion can be defined in an appropriate way.

In summary, it is proposed therein to start with a single control point, placed at the most prominent SIFT feature. Starting from this control point, the position and the displacement is optimized until optimal similarity between the reference image and the warped floating image is reached. Then this optimal control point configuration is used as starting configuration for the next optimization run, and an additional control point is placed at the next prominent SIFT feature. All control points together are optimized further, using a locally convergent optimization strategy. The iterative placement of an additional control point at the next prominent SIFT feature is continued as long as a significant improvement of the similarity measure can be reached.

Contrary to a completely random initial positioning of the control points, the proposed method avoids placing control points in areas void of significant grey value structures where adjusting the position and the displacement will hardly change the similarity measure and hence will not efficiently improve image similarity. Furthermore, it makes the registration algorithm more deterministic and reproducible on important aspect for acceptance in clinical practice.

It should be noted that the present invention may be applied to CT images, magnetic resonance images (MRI), positron emitted tomography images (PET), single photon emission computed tomography images (SPECT) or ultrasound (US) modalities. Also, other data sets may be used.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A method of registering a first image and a second image, the method comprising:
identifying (S1) one or more significant features within said first image;
placing (S2) at least one control point at a significant feature within said first image, determining (S7) a first parameter setting defining a position and displacement parameters in respect of said at least one control point so as to elastically deform (S8) said first image and thereby to improve the similarity between said first image and said second image, and repeating the steps of:
placing (S6) at least one additional control point within said first image, determining (S7) a second parameter setting in respect of said at least one additional control point and defining a position and displacement parameters so as to elastically deform (S8) said first image and thereby to further improve said similarity between said first image and said second image until a predetermined criterion is met.

2. A method according to claim 1, wherein said at least one additional control point is placed at another significant feature within said first image.

3. A method according to claim 1, wherein a SIFT algorithm is employed to identify (S1) significant feature within said first image.

4. A method according to claim 1, wherein said predetermined criterion comprises that the similarity between said first and said second image has reached at least a predetermined level.

5. A method according to claim 1, wherein at the start (S1) of the method, a single control point is randomly placed (S2) with said first image and a parameter setting in respect of said single control point is determined (S3).

6. A method according to claim 1, wherein each time one or more additional control points are added, optimal parameter settings in respect of all control points in said first image are determined (S7).

7. A method according to claim 1, wherein control points are added (S6) to said first image one-by-one and elastic deformation in respect of the respective control point set is performed (S8) until said predetermined criterion is met.

8. A method according to claim 1, wherein the parameter settings of each control point are optimised so as to optimise a similarity measure.

9. A method according to claim 1, wherein a similarity measure is obtained (S9) after each elastic deformation operation and the amount by which the similarity between the first image and the second image has improved is determined (S10) and compared (S11) with a stopping criterion, wherein an additional one or more control points are added only if said stopping criterion is not met.

10. An image processing device for performing registration of a first image and a second image, the device comprising a memory (2) for storing said second image, means for receiving image data in respect of said first image, and processing means (1) configured to:
identify one or more significant features within said first image;
place at least one control point within said first image, and determine a first parameter setting defining a position and displacement parameter in respect of said at least one control point so as to elastically deform said first image and thereby to improve the similarity between said first image and said second image; and then the steps of:
placing at least one additional control point within said first image, and determining a second parameter setting in respect of said at least one additional control point defining a position and displacement parameters so as to elastically deform said first image and thereby to further improve said similarity between said first image and said second image, until a predetermined criterion is met.

11. A software program for registering a first image and a second image, wherein the software program causes a processor (1) to:
identify one or more significant features within said first image;
place at least one control point at a significant feature within said first image, and determine a first parameter setting defining a position and displacement parameters in respect of said at least one control point so as to elastically deform said first image and thereby to improve the similarity between said first image and said second image, and then repeat the steps of:
placing at least one additional control point within said first image, and determining a second parameter setting in respect of said at least one additional control point defining a position and displacement parameters so as to elastically deform said first image and thereby to further improve said similarity between said first image and said second image, until a predetermined criterion is met.
